(19) United States
(12) Patent Application Publication
(10) Pub. No.: US 2021/0383289 A1
(43) Pub. Date: Dec. 9, 2021

(54) DYNAMIC WORKFLOW SELECTION USING STRUCTURE AND CONTEXT FOR SCALABLE OPTIMIZATION

(71) Applicant: Outreach Corporation, Seattle, WA (US)

(72) Inventors: Pavel Dmitriev, Bellevue, WA (US); Yifei Huang, Kirkland, WA (US)

(21) Appl. No.: 17/338,467

(22) Filed: Jun. 3, 2021

Related U.S. Application Data
(60) Provisional application No. 63/034,776, filed on Jun. 4, 2020.

(51) Int. Cl. G06Q 10/06; G06F 9/38; G06F 9/355; G06N 20/00

(52) U.S. Cl. CPC G06Q 10/0633; G06Q 10/0639; G06N 20/00; G06F 9/3555; G06F 9/3836

(57) ABSTRACT

A system and a method are disclosed for recommending a change to improve performance of a target workflow. A workflow management system receives the target workflow intended to be used in a particular context to achieve a target result. The target workflow has a structure with a plurality of steps performed in a predefined order, but there may be options for modifying the workflow to lead to better performance (e.g., change type of action performed in a step, change order of steps, add a new step). The workflow management system identifies candidate workflows that are similar to the target workflow and identifies historical changes that have been made to these candidate workflows. Using a machine learning model, the workflow management system determines a change from one of the historical changes made to the candidate workflows associated with the highest expected impact when applied to the target workflow.

### CROSS-REFERENCES TO OTHER APPLICATIONS

This application claims the benefits of U.S. Provisional Application No. 63/034,776, filed on Jun. 4, 2020, which is incorporated by reference in its entirety.

### TECHNICAL FIELD

This disclosure is generally directed to workflow optimization, and more particularly to using machine learning to identifying changes to apply to a workflow to improve performance of the workflow.

### BACKGROUND

Traditionally, designing and optimizing a given workflow with a sequence of steps involves relying on experts to perform tests to determine what impact individual steps of the workflow have on a performance of the workflow to determine whether there is a way to change the workflow to improve the performance. However, because there are so many different options for changing the workflow (e.g., replace a step with a different step, remove a step, add a step, change time at which a step is performed, change time in between steps), it is difficult and computationally intensive to test different options for a given workflow to find the best way to improve the performance in a scalable manner as historical ground truth data grows. Instead, data associated with other workflows in an isolated subset of historical data may be analyzed to determine a few promising changes to implement on the workflow. However, with the tremendous amount of data available on hundreds of thousands or millions of workflows that are each geared towards a particular industry, market, prospect, or product, it is prohibitively computationally expensive from processor, network usage, and memory usage perspectives to sort through large data pools and isolate portions of data that are relevant for selecting the promising changes for a given workflow. When there is such a large volume of data, existing machine learning implementations are insufficient to navigate above-described inefficiencies.

### SUMMARY

Systems and methods disclosed herein address the above-described problems relating to analysis of historical workflow data in a scalable manner and selecting a change that is expected to have the most positive impact on the performance of a target workflow from large pools of historical data in a computationally efficient manner that preserves memory, processing power, and network usage. There are many different options for changing the target workflow, and a workflow management system selects candidate changes previously made to candidate workflows similar to the target workflow to be applied to the target workflow. A machine learning model is trained to receive features associated with the candidate changes and output an expected impact for each of the candidate changes. The workflow management system selects the change associated with the highest expected impact and tests the actual impact that the selected change has on the performance of the target workflow. Because it is computationally inefficient to test all of the possible changes, the workflow management system identifies a candidate change that previously had positive impact on the performance of a candidate workflow similar to the target workflow and tests this candidate change because it is more likely to have positive impact on the target workflow than a randomly selected change.

Systems and methods are disclosed herein for a workflow management system that identifies a predetermined number of candidate workflows that are similar to the target workflow from a large number of historical workflows maintained in the workflow management system. The workflow management system determines a target workflow having first context attributes, where the target workflow has a first structure having a plurality of steps in a predefined order. The workflow management system determines a first set of candidate workflows that have the first context attributes and also have the first structure of the target workflow. After adding the first set of candidate workflows to a pool of candidate workflows, the workflow management system determines whether the pool has a predefined number of candidate workflows. If the pool does not have the predefined number of candidate workflows, the workflow management system determines a second set of candidate workflows having the first context attributes, where each candidate workflow in the second set has a structure with a number of structural changes relative to the first structure.

After adding the second set of candidate workflows to the pool of candidate workflows, if the pool does not have the predefined number of candidate workflows, the workflow management system determines whether a maximum number of structural changes has been reached. If the maximum number of structural changes has been reached, the workflow management system identifies a second context attribute having a threshold strength of similarity to the first context attributes of the target workflow. The workflow management system determines a third set of candidate workflows having the second context attribute and the first structure and adds the third set of candidate workflows to the pool. If the pool has the predefined number of candidate workflow, the workflow management system selects a new workflow from the pool and transmits a recommendation including the new workflow to a user associated with the target workflow.

In other words, the workflow management system first searches for candidate workflows that have the same structure or similar structures as the target workflow within the same context as the target workflow. If there are not enough of such candidate workflows in the same context as the target workflow, the workflow management system searches for candidate workflows that have the same structure of similar structures as the target workflow within a context that is similar to the context of the target workflow.

Systems and methods are disclosed herein for selecting a change for a target workflow expected to have positive impact on the performance of a target workflow based on a machine learning model. The workflow management system receives a target workflow having a structure with a plurality of steps in a predefined order. The workflow management system identifies a plurality of candidate changes to the target workflow, the plurality of candidate changes corresponding to changes that were previously made to candidate workflows similar to the target workflow. For each of the candidate changes, the workflow management system generates a feature vector with a set of features associated with the candidate change and inputs the feature vector into a machine learning model. The machine learning model is trained using training data including changes made to historical workflows and corresponding changes in performance of the historical workflows, and the machine learning model outputs an expected impact for the candidate change based on the input feature vector. The workflow management system selects a candidate change that has the highest expected impact and applies the selected candidate change to the target workflow.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 illustrates a block diagram of a computing environment for a workflow management system, according to an embodiment.

FIG. 2 illustrates an exemplary workflow, according to an embodiment

FIG. 3 illustrates a block diagram of modules and databases used by a workflow management system, according to an embodiment.

FIG. 4 illustrates exemplary data structures associated with workflows, according to an embodiment.

FIG. 5 illustrates an exemplary data flow for selecting candidate workflows, according to an embodiment.

FIG. 6 illustrates an exemplary data flow for selecting a change for a target workflow, according to an embodiment.

FIG. 7 illustrates exemplary data structures associated with historical changes to workflows, according to an embodiment.

FIG. 8 is an exemplary user interface for presenting a recommended change to a workflow, according to an embodiment.

FIGS. 9A and 9B illustrate an exemplary flowchart depicting a process for selecting a new workflow, according to an embodiment.

FIG. 10 illustrates an exemplary flowchart depicting a process for selecting a change to apply to a target workflow, according to an embodiment.

FIG. 11 is a block diagram illustrating components of an example machine able to read instructions from a machine-readable medium and execute them in a processor (or controller).

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Computing Environment for Workflow Management System

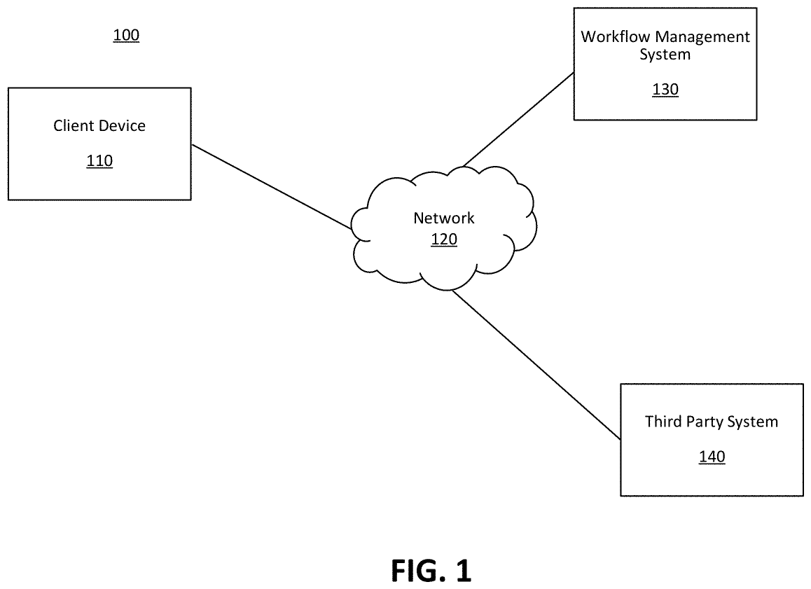

FIG. 1 illustrates a block diagram of a computing environment 100 for a workflow management system 130, according to an embodiment. Environment 100 includes one or more client devices 110, a workflow management system 130, and one or more third party systems 140 that communicate with each other over a network 120. FIG. 1 illustrates one client device 110 and one third party system 140, but there may be multiple instances of each of these entities, and the functionality of the workflow management system 130 may be distributed or replicated across multiple servers.

A client device 110 is a device operated by a user (e.g., sales representative, marketing personnel, manager, recruiter) associated with an organization (e.g., a company). The client device 110 may receive input from the user and perform a sequence of steps in a workflow. As used herein, the term “workflow” refers to a sequence of steps involving one or more different types of actions performed in a predetermined order. The types of actions included in a workflow depends on the context in which the workflow is used. The term “context” refers to circumstances or a scenario in which a workflow is used. Context can be represented by a set of context attributes. Examples of context attributes include industry (e.g., technology, finance, legal, sports, entertainment), language used to perform the steps of the workflow, role of target audience (e.g., sales leader, CFO, partner, engineer), role of user performing the workflow (e.g., sales representative, human resources personnel, lawyer, manager), demographics of target audience (e.g., geography, age), or other such attributes. The sequence of steps in the workflow are arranged to have a particular structure. The term “structure” refers to an arrangement of steps in a workflow. Structure can be represented by a set of structure attributes such as a number of steps in the workflow, order in which the steps are performed (e.g., calling a customer and then emailing the customer vs. emailing the customer and then calling the customer), a time at which one or more steps are performed (e.g., step 2 performed on Sunday at 2 pm), a time duration to wait before or after a step (e.g., 24 hours before step 2, 48 hours after step 2), type of call script, type of email template, or other such attributes.

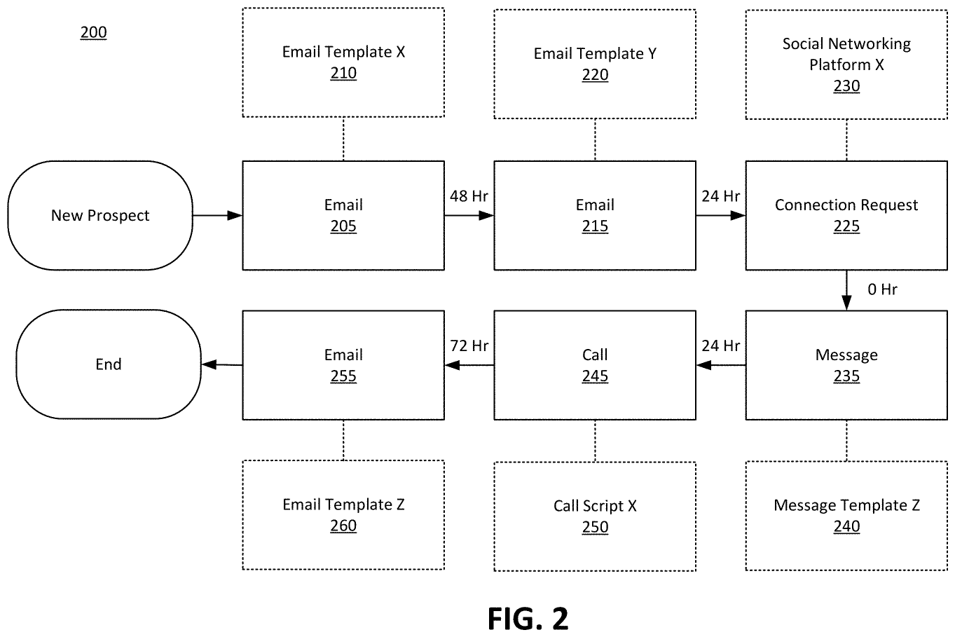

An exemplary workflow 200 is illustrated in FIG. 2. The workflow 200 is intended to be performed by a recruiter for a company in the technology industry to receive a response from a prospect for an engineer role at the company. The workflow 200 includes a first step 205 of sending an email according to email template X 210, a second step 215 of sending a second email according to email template Y 220, a third step 225 of sending a connection request on social networking platform X 230, a fourth step 235 of sending a message according to message template Z 240, a fifth step 245 of calling according to call script X 250, and a sixth step 255 of sending a third email according to email template Z 260. The types of actions (e.g., email, connection request, message, call) performed in each of the steps, order of the steps, and time in between steps may be specified by a user associated with the workflow. In another exemplary workflow for performing user onboarding may include steps of account creation, account activation, notifications to introduce new product features, reminders to perform a task, or other onboarding related actions. The steps of a workflow are not independent of each other. For example, in the workflow 200, the email sent in the second step 215 may reference information shared in the email from the first step 205, and the message sent in the fourth step 235 may reference information shared in the email from the first step 205 or the email sent in the second step 215. A workflow may include any number of steps, any combination on types of actions, and any structure. Depending on the workflow, performance may be measured using one or more metrics such as number of meetings booked, number of email responses, number of answered calls, amount of revenue, average time to receive positive response, user ratings, or other indicators.

Because it is difficult to keep track of the status of workflows especially when responsible for a large number of workflows at the same time, the client device 110 may use functions of the workflow management system 130 to perform the steps of the workflow. For example, the workflow management system 130 may be integrated with the plurality of third party systems 140 (e.g., an email provider for an emailing step, a social networking system for a friend request step), allowing the client device 110 to perform the steps in the workflows from one platform. In some embodiments, the workflow management system 130 may be automated to perform one or more of the steps of workflows (e.g., send a follow up email). In other embodiments, the workflow management system 130 may track the progress of workflows and sends notifications to the client device 110 to notify a user that it is time to perform a next step of a workflow (e.g., a reminder to perform step 2 of workflow XYZ in 15 min by making a phone call to a potential client). Furthermore, since the workflow management system 130 manages a large variety of workflows and has insights on successful and efficient workflows, the client device 110 may send a request to the workflow management system 130 for a recommendation on changes that could be made to optimizing a target workflow of the client device 110. The client device 110 may have an application installed thereon to access the functions of the workflow management system 130.

The client device 110 is a computing device capable of receiving user input as well as transmitting and/or receiving data via the network 102. In one embodiment, a client device 110 is a smartphone, a tablet or a conventional computer system, such as a desktop or laptop computer. Alternatively, a client device 110 may be a device having computer functionality that accesses a set of mobile applications. A client device 110 is configured to communicate via the network 120. In one embodiment, the client device 110 executes a mobile application allowing a user of the client device 110 to interact with the workflow management system 130. For example, the client device 110 executes a browser application that may enable interaction between the client device 110 and the workflow management system 130 via the network 120. In another embodiment, a client device 110 interacts with the workflow management system 130 through an application programming interface (API) running on a native operating system of the client device 110, such as IOS® or ANDROID™.

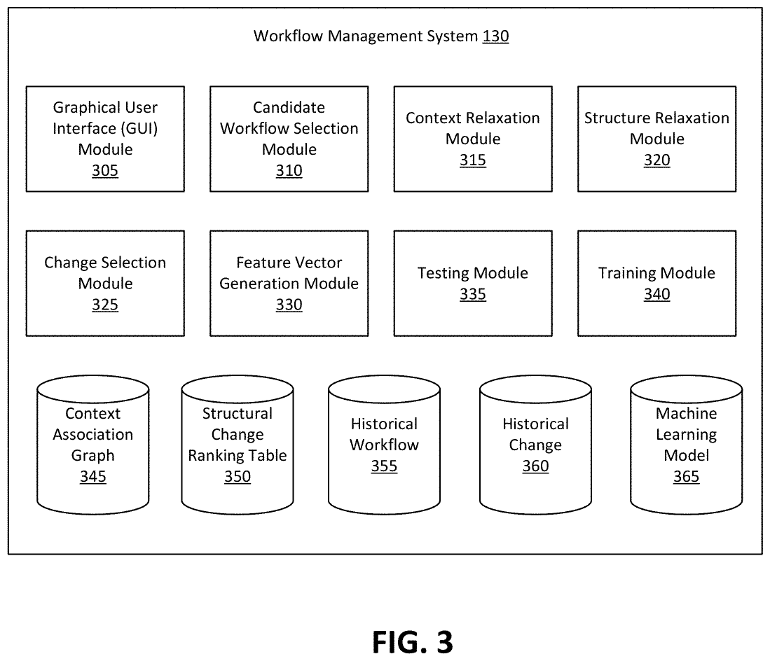

The workflow management system 130 receives a request from a client device 110 and determines an optimized workflow for the client device 110. The workflow management system 130 manages a large volume of data associated with historical workflows of various client devices 110 including historical changes applied to historical workflows and resulting changes in performance. In some embodiments, the request specifies a pre-existing target workflow of the client device 110 that has a plurality of steps in a particular order to be optimized. The workflow management system 130 searches through historical workflows to identify candidate workflows that are similar to the workflow specified in the request. After identifying the candidate workflows, the workflow management system 130 determines historical changes that were made to the candidate workflows and resulting changes in performance. Using a machine learning model, the workflow management system 130 determines an expected impact for each of the historical changes and selects a historical change expected to have the most positive impact on the target workflow. The workflow management system 130 applies the selected historical change to the target workflow and tests the actual impact of the selected historical change to determine whether to keep applying the change to the target workflow. In some embodiments, instead of specifying a target workflow and its steps, the request may specify one or more context attributes (e.g., industry, persona, language, geography), and the workflow management system 130 may identify a target workflow for the client device 110. After identifying the target workflow, the target workflow can be further optimized. Details on the workflow management system 130 are detailed below with respect to FIG. 3.

The system environment may additionally include one or more third party systems 140. One or more steps of a workflow may be performed using services of a third party system 140. For example, a third party system 140 may be a social networking system, an email service provider, a call application provider, an advertising network, an advertisement publisher, or other types of service providers. The workflow management system 130 may be integrated with the one or more third party systems 140 using APIs, and the steps in workflows performed using functions of the one or more third party systems 140 may be executed through the workflow management system 130.

The client device 110, the workflow management system 130, and the third party system 140 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML).

### Exemplary Workflow Management System

FIG. 3 illustrates a block diagram of modules and databases used by a workflow management system 130, according to an embodiment. The workflow management system 130 as depicted in FIG. 3 includes a graphical user interface (GUI) module 305, a candidate workflow selection module 310, a context relaxation module 315, a structure relaxation module 320, a change selection module 325, a feature vector generation module 330, a testing module 335, a training module 340, a context association graph database 345, a structural change ranking graph database 350, a historical workflow database 355, a historical change database 360, and a machine learning model database 365. The modules and databases depicted in FIG. 3 are merely exemplary; more or fewer modules and/or databases may be used by the workflow management system 130 in order to achieve the functionality described herein. Moreover, these modules and/or databases may be located in a single server, or may be distributed across multiple servers. Some functionality of the workflow management system 130 may be installed directly on the client device 110 as a component of an application associated with the workflow management system 130.

The GUI module 305 generates a GUI that is presented to a user via a client device 110 to receive input from the user specifying a target workflow and to present a recommendation for a change that is likely to improve performance of the target workflow. In some embodiments, the input may include a request for optimizing a target workflow, the request specifying a plurality of steps in the target workflow (e.g., types of actions, call script, email templates, timing) and an order and timing of the plurality of steps. That is, the workflow management system 130 receives details on an existing target workflow associated with the requesting user, and the workflow management system 130 determines a change (or a few changes) that has a likelihood greater than a threshold to improve performance if applied to the target workflow. In other embodiments, the input may include a request for the workflow management system 130 to generate a new workflow based on context attributes or other preferences specified by the user. The context attributes may indicate a scenario in which the new workflow will be used such as the industry, language, and target audience and user preferences such as minimum/maximum number of steps in the workflow, preferred third party systems 140, total duration of workflow, and the like. The workflow management system 130 may select one of the historical workflows that is most likely to lead to highest performance given the user input.

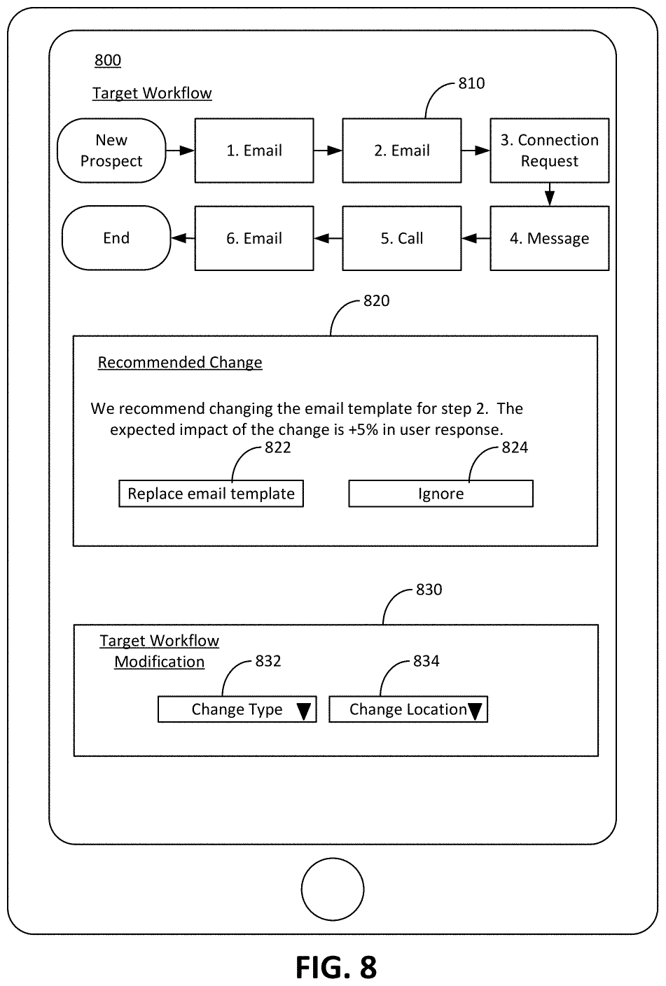

The GUI includes graphical elements that the user can interact with to select the plurality of steps in the target workflow from a list of possible action types (e.g., dropdown menus) and indicate the order of the plurality of steps (e.g., drag and drop, numbered input fields). The GUI may include input fields for receiving input of context attributes for a new workflow. In some embodiments, the input may be an identification of one of the historical workflows 355 associated with the client device 110 that is already being managed by the workflow management system 130. After receiving the input from the user and generating a recommendation to implement a change, the workflow management system 130 presents the recommendation to the user via the GUI. An exemplary GUI is described with respect to FIG. 8.

The candidate workflow selection module 310 identifies candidate workflows that are similar to a target workflow. As discussed above, given time and computation power limitations, it is not scalable to perform tests for all possible changes for a given target workflow to determine which change would be most effective for improving performance of the target workflow. Instead, the workflow management system 130 identifies a threshold number of candidate workflows from the historical workflows 355 that are similar to the target workflow and analyzes historical changes that have previously been tested for these candidate workflow to determine which historical change is expected to have the highest impact if applied to the target workflow. However, given the large number of historical workflows 355, it is computationally inefficient to compare the target workflow to each historical workflow 355, determine a measure of similarity between the target workflow and the historical workflow 355, and then select a threshold number of historical workflows 355 as candidate workflows. Instead, the candidate workflow selection module 310 identifies the candidate workflows by iterating through subsets of the historical workflows 355 by relaxing one context attribute or one structure attribute at a time and identifying historical workflows that satisfy the relaxed parameters until the threshold number of historical workflows 355 similar to the target workflow. This ensures that the candidate workflow selection module 310 efficiently references a sufficiently large pool of historical data that is most likely to yield a positive result while avoiding having to reference all data in a very large data pool, saving on processing power and preserving bandwidth resources in a scalable manner.

The workflow management system 130 has a variety of data associated with the historical workflows 355 that are used to identify the candidate workflows. The data may include context attributes, structure attributes, and historical performance of the historical workflows 355. The data associated with a historical workflow 355 may be provided by a client device 110 associated with the historical workflow 355, based on activity of the client device 110 within the workflow management system 130, or received from one or more third party systems 140.

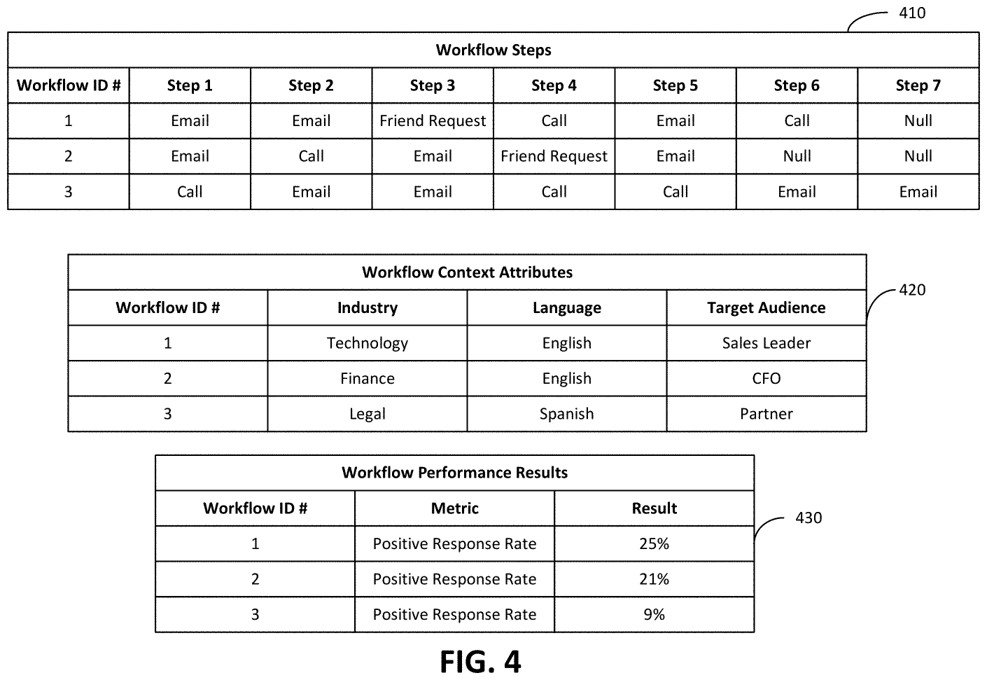

FIG. 4 illustrates exemplary data structures associated with workflows, according to an embodiment. A first table 410 includes structural attributes of historical workflows 355. The first table 410 describes steps of workflows and includes the action types (e.g., email, friend request, call) of steps in historical workflows 355. Although not illustrated in FIG. 4, metadata describing the steps of the historical workflows may also be stored in relation to the steps. For example, for a step of sending an email or making a phone call, the type of email template or call script to be used may be defined. For the step of sending a friend request, the platform for sending the friend request (e.g., name of social networking platform) may be defined. Additionally, timing information associated with one or more steps in the historical workflow 355 is also stored. The timing information may describe date, day, or time at which a step is performed (e.g., Monday at 8 am, 3 days before Christmas) or may describe a time interval between steps (e.g., 24 hours between steps 2 and 3). A structure of a flowchart may be represented as a graph with vertices representing steps and edges representing the order of the steps. Vertices may be annotated with attributes such as action type, content, and instructions for performing the step, and edges are annotated with wait times between the steps.

A second table 420 includes context attributes associated with historical workflows 355. In the example shown in FIG. 4, the context attributes include the industry that the historical workflow 355 is used in, the language in which steps are performed in, and the target audience of the historical workflow 355. A third table 430 includes performance results of the historical workflows 355. The metric for measuring the performance of the historical workflows 355 is positive response rate. The positive response rate may refer to the target audience responding to an email, accepting friend request, receiving phone call, setting up a meeting, making a purchase, leaving a positive review, or other indication that the workflow was effective. In some embodiments, a plurality of metrics may be used to determine the performance of the historical workflows 355 in different aspects. In some embodiments, the plurality of metrics may be aggregated and represented as the positive response rate.

Referring back to FIG. 3, the candidate workflow selection module 310 determines the context attributes associated with the target workflow and the structure attributes associated with the target workflow based on the data. The context attributes and structure attributes are two aspects for determining similarity to the target workflow. The target workflow and candidate workflows should be used in similar contexts because techniques used in a workflow in one context may not transfer to another context if the two contexts are not similar. For example, workflows that are successful in the financial industry may be expected to be successful in the legal industry because of commonalities in context attributes of the two industries. However, workflows that are successful in the financial industry may not be expected to be successful in the sports industry because the context attributes associated with the financial industry and the sports industry are too different. To reduce time and computational resources, the candidate workflow selection module 310 does not select random subsets of historical workflows 355 to determine whether there are any workflows that are similar to the target workflows 355 in the selected subsets. Instead, the candidate workflow selection module 310 determines the context attributes associated with the target workflow and filters the historical workflows 355 for those that have the same context attributes of the target workflow. For example, if the target workflow is the workflow 200, the context attributes may indicate that it is for the technology industry, performed in English, and the target audience is a prospective hire. The candidate workflow selection module 310 determines whether there are historical workflows 355 that have all (or at least a subset) of the context attributes of the target workflow 200.

The workflow management system 130 may represent relationships between different context attributes in the context association graph 345. The context association graph 345 may be a knowledge graph in which values of context attributes (e.g., industry=finance, language=English, target audience=CEO) correspond to vertices and edges between two vertices show strength of association between context attributes. The target workflow is associated with a maximum context relaxation value (Cmax) which indicates a maximum amount that the threshold strength of similarity between a context attribute of the target workflow and a context attribute of a historical workflow 355 that can be relaxed for the historical workflow 355 to be considered similar enough to be a candidate workflow.

If there is a set of historical workflows 355 that have the same context attributes as the target workflow, the candidate workflow selection module 310 determines whether there are any historical workflows 355 with the same structure attributes or similar structure attributes as the target workflow. In addition to having the same or similar context attributes, the target workflow and the candidate workflows should have same or similar steps that are arranged in the same or similar order to be considered similar workflows. The types of actions performed in the steps, the order in which the steps are arranged, time at which the steps are performed, time intervals between steps, and other structure attributes also indicate the similarity between the target workflow and a historical workflow 355. The historical workflows 355 with the same structure attributes and same context attributes as the target workflow are selected to be candidate workflows.

If there are fewer than the threshold number of candidate workflows, the candidate workflow selection module 310 iteratively relaxes a number of structural changes allowed between the target workflow and a candidate workflow. During each iteration, the candidate workflow selection module 310 increments the number of structural changes allowed by one and searches through the set of historical workflows 355 with the same context attributes as the target workflow that have the number of structural changes relative to the target workflow. The target workflow is associated with a maximum structure relaxation value (Smax) which indicates a maximum number of changes that can be made relative to the structure of the target workflow to be considered to have a similar structure as the target workflow. Relaxing the number of structural change allowing an additional change relative to the structure of the target workflow and searching for historical workflows 355 that satisfy the relaxed structure attribute. There are many options for making structural changes, and the candidate workflow selection module 310 uses the structure relaxation module 320 to determine the order in which to relax the structural attribute in the iterations. For a given iteration, the candidate workflow selection module 310 applies the structure relaxation module 320 that makes a query to the structural change ranking table 345 to determine which structural attribute to relax. The structural change ranking table 345 may store a plurality of structural changes and a value representing a likelihood of the structural change resulting in improved performance. The structure relaxation module 320 iteratively returns the structural change to be considered in the order of decreasing likelihood.

In an example, the structural change ranking table 345 includes “Add Call Step” and “Change Timing of Email Step,” where “Add Call Step” has a higher value than the “change Timing of Email Step.” The candidate workflow selection module 310 first adds any historical workflows 355 having a structure with an additional call step to the pool of candidate workflows and checks whether the number of candidate workflows in the pool satisfies the threshold number of candidate workflows. If the threshold number is not satisfied, the candidate workflow selection module 320 then adds any historical workflows 335 that has a different timing in the email step compared to the structure of the target workflow. The candidate workflow selection module 310 continues to identify historical workflows corresponding to structural changes associated with lower values until it reaches Smax number of structural changes.

In some embodiments, the structural change ranking table 350 may be incorporated into the context association graph 345. Depending on the context attributes, likelihood of success of certain structural changes may vary, so the workflow management system 130 may store multiple structural change ranking tables 350 where each structural change ranking table corresponds to a different context attribute. This can result in a particular structural change having higher priority in some contexts, and lower priority in others. That is, the value associated with a structural change in one context (e.g., finance industry) may be different from the value associated with the same structural change in another context (e.g., technology industry). In other embodiments, the structural change ranking table 350 may be applied globally regardless of context.

After relaxing the structure attributes to Smax, if there are not enough candidate workflows in the pool to satisfy the threshold number, the candidate workflow selection module 310 relaxes the threshold strength of similarity between a context attribute of the target workflow and a context attribute of a historical workflow 355. To determine which context attribute to relax, the candidate workflow selection module 310 applies the context relaxation module 315 that determine which context attribute of the target workflow to relax based on a query to the context association graph 345. The query may include the context attributes of the target workflow and the threshold strength of similarity. The context relaxation module 315 may return a context attribute to search for in candidate workflows, where the returned context attribute is connected to at least one of the context attributes of the target workflow by an edge having at least the threshold strength of similarity. If there are multiple context attributes connected to at least one of the context attributes of the target workflow having the at least threshold strength of similarity, the context relaxation module 315 may select the one with the highest strength of similarity. For example, if the target workflow is in the finance industry, and an edge connecting the finance industry to the legal industry has a higher weight than an edge connecting the finance industry to the technology industry, the context relaxation module 315 determines that the finance industry is more similar to the legal industry than the technology industry. Therefore, the candidate selection module 310 searches through workflows associated with the finance industry before workflows associated with the technology industry.

After relaxing a context attribute, the candidate workflow selection module 310 identifies workflows that have the same structure attributes as the target workflow. The candidate workflow selection module 310 starts with no structural changes and iteratively relaxes structural changes in the order of most promising structural changes until reaching Smax. Every time Smax is reached for a given iteration, a context attribute is relaxed until Cmax is reached. During any stage of selecting candidate workflows, when the threshold number of candidate workflows has been identified, the candidate workflow selection module 310 stops searching for candidate workflows.

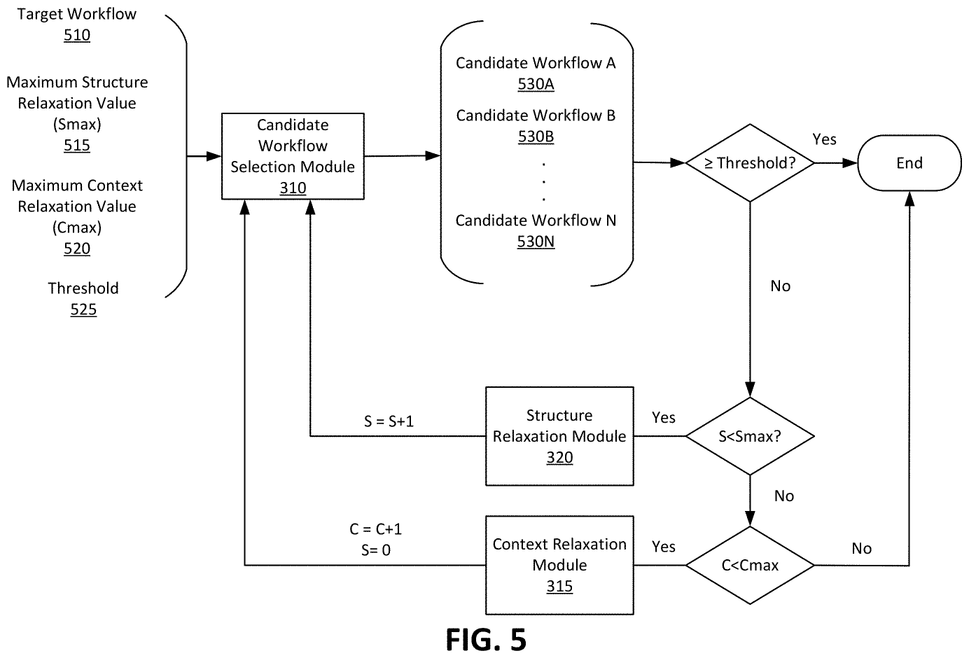

The process performed by the candidate workflow selection module 310 is summarized in FIG. 5 which illustrates an exemplary data flow for selecting candidate workflows that are similar to a target workflow. The candidate workflow selection module 210 receives a target workflow 510, a maximum structure relaxation value (Smax) 515, a maximum context relaxation value (Cmax) 520, and a threshold number of candidate workflows 525. In some embodiments, Smax 515, Cmax 520, and threshold number 525 may be values predetermined by the workflow management system 130. In other embodiments, one or more of Smax 515, Cmax 520, and threshold number 525 may be based on user preferences.

The candidate workflow selection module 310 determines context attributes and structure attributes associated with the target workflow 510. First, the candidate workflow selection module 310 identifies candidate workflows 530 with the same context attributes and the same structure attributes as the target workflow 510. If the number of candidate workflows 530 is greater or equal to the threshold, the candidate workflow selection module 310 stops the process. However, if the number of candidate workflows 530 is less than the threshold, the candidate workflow selection module 310 iteratively searches for additional candidate workflows 530 with a number of structural changes relative to the structure of the target workflow, where the number of structural changes increments by one in which iteration. After each iteration, if the number of structural changes is less than Smax, the structure relaxation module 320 selects the most promising structural change for the candidate workflow selection module 310 to look for in the next iteration. If the number of structural changes is equal to Smax, and the number of context relaxation is equal to Cmax, the candidate workflow selection module 310 stops the process. However, if the number of structural changes is equal to Smax, and the number of context relaxation module is less than Cmax, the context relaxation module 315 determines which context attribute to relax.

The candidate workflow selection module 310 gradually relaxes a threshold strength of similarity between context attributes of the target workflow and context attributes of candidate workflows. The order in which to relax the context attributes is determined by the context relaxation module 315 according to the context association graph 345. Context relaxation is an “outer loop,” where each time the threshold strength of similarity in context is relaxed, the “inner loop” of structure relaxation is iterated until reaching Smax. After reaching Smax, if the candidate workflow selection module 310 has not identified enough candidate workflows 530, then the threshold strength of similarity is further relaxed until reaching Cmax.

In some embodiments, after selecting the candidate workflows that are similar to the target workflow, the candidate workflow selection module 310 determines expected performance of the candidate workflows and selects a candidate workflow that is expected to perform better than the target workflow to replace the target workflow. For each candidate workflow, the candidate workflow selection module 310 may apply the machine learning model 365 that outputs an expected performance of the candidate workflow given the context attributes of the target workflow. The inputs to the machine learning model 365 may include a context similarity score, a structure transferability score, and current performance of the candidate workflow. The context similarity score represents a strength of similarity between context attributes of the target workflow and context attributes of the candidate workflow. The context similarity score may be an aggregate score based on weights of edges that connect context attributes of the target workflow and candidate workflow in the context association graph 345. The structure transferability score may represent a likelihood that the candidate workflow would perform within a threshold of current performance (e.g., within 5% of current performance metrics) when applied in the context of the target workflow instead of its current context. That is, it indicates a likelihood of the candidate workflow performing similarly given the context attributes of the target workflow or how well the candidate workflow would transfer to the context of the target workflow.

For each candidate workflow, the candidate workflow selection module 310 provides the context similarity score, the structure transferability score, and current performance of the candidate workflow as input to the machine learning model 365. The machine learning model 365 outputs an expected performance of the candidate workflow given the context attributes of the target workflow. The machine learning model 365 may be trained based on historical performance of historical workflows 355. The historical performance may be tracked by the workflow management system 130 or a third party system 140. In some embodiments, the machine learning model 365 may be trained based on a difference between an expected performance of a candidate workflow predicted by the machine learning model 365 and actual performance of candidate workflow after being deployed. The training data associated with a candidate workflow may be associated with a weight based on the absolute difference between the expected and actual performance. For example, for training data associated with candidate workflows in which the difference is greater than a threshold (e.g., the machine learning model 365 is not making accurate predictions) may be weighed higher compared to training data associated with candidate workflows in which the difference is lower than the threshold (e.g., the machine learning model 365 is making sufficiently accurate predictions). After the candidate workflow selection module 310 has determined the expected performance for all of the candidate workflows, the candidate workflow selection module 310 ranks the candidate workflow based on the estimated performance and selects one with the highest estimated performance. If this highest estimated performance is greater than the current performance of the target workflow, the corresponding candidate workflow is recommended to replace the target workflow.

In some embodiments, after the candidate workflow selection module 310 selects the candidate workflows, the change selection module 325 determines historical changes 360 that have been made to the candidate workflows and applies the machine learning model 365 to select a change that is expected to have the most positive impact on the performance of the target workflow. The change selection module 325 receives candidate workflows (e.g., candidate workflow 530) selected by the candidate workflow selection module 310. Each of the candidate workflows may be associated with one or more historical changes 360 that were made to the candidate workflow and the resulting change in performance. The historical changes 360 previously made to the candidate workflows are candidate changes that could be applied to the target workflow, and the change selection module 325 selects one of the candidate changes that is expected to have the most positive impact to be recommended for the target workflow.

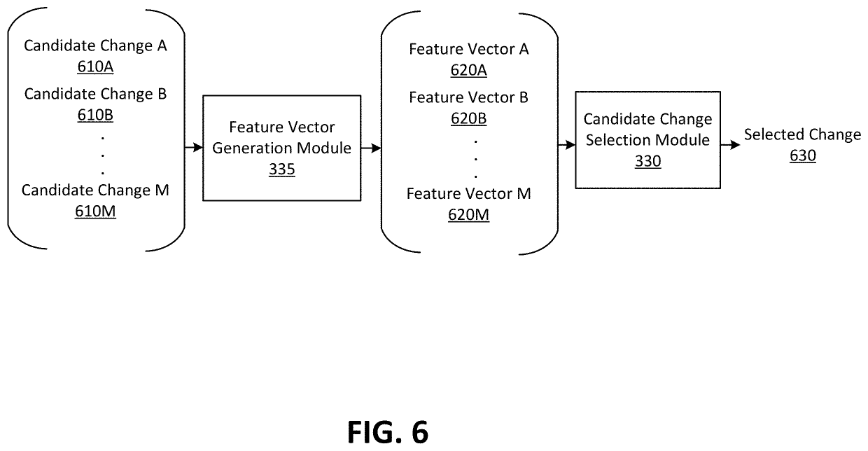

The process of selecting the best change by the change selection module 325 is described with respect to FIG. 6. FIG. 6 illustrates an exemplary data flow for selecting a change for a target workflow. Candidate changes 610 associated with candidate workflows selected by the candidate workflow selection module 310 are identified from the historical changes 360. Each candidate workflow may be associated with one or more candidate changes 610. For each of the candidate change, the feature vector generation module 335 generates a feature vector 620 based on data associated with the candidate changes 610 (e.g., tables 710, 720) and/or data associated with the corresponding candidate workflow (e.g., tables 410, 420, 430). For example, the feature vector 620 for a particular candidate change 610 may include one or more of: type of change, historical impact of the historical change, a number of times the historical change was tested, strength of similarity between context attributes of the target workflow and the candidate workflow, and how long ago the historical change was tested.

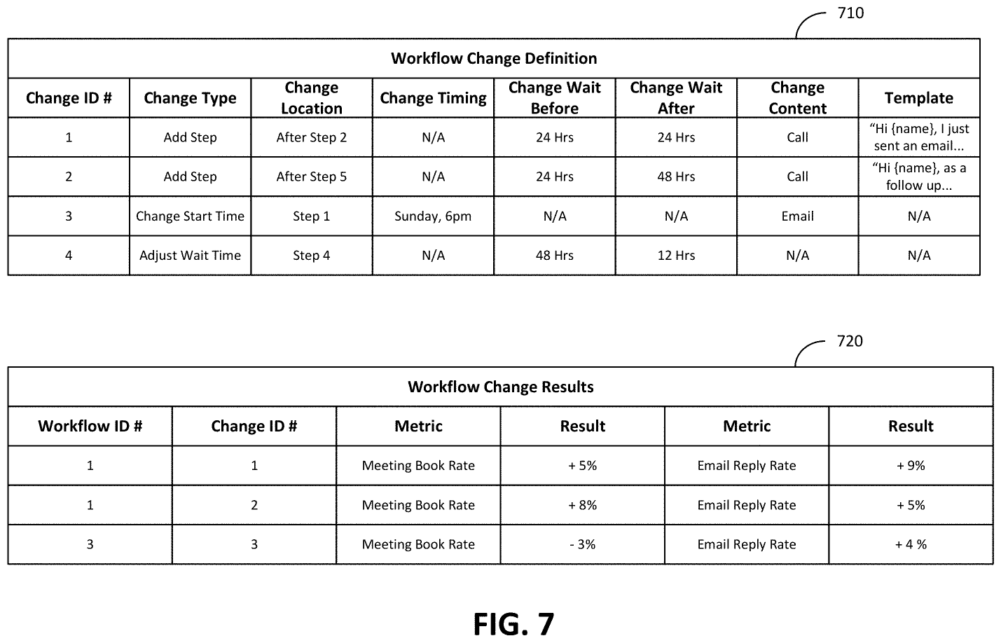

Exemplary data structures associated with historical changes 360 are illustrated in FIG. 7. A first table 710 includes a definition for each of the historical changes 360 that indicate a type of change (e.g., add step, change start time, adjust wait time, replace step), a location within the structure of the workflow that the historical change 360 was made, a change in time, a change in content, a change in template, or other relevant data associated with the historical changes 360. A second table 720 shows performance results of the historical changes 360. The second table 720 logs the performance results according to workflow identification of workflows that the historical changes were made to and change identification. The second table 720 may include performance results in one or more performance metrics (e.g., meeting book rate, email reply rate, user conversion, revenue). Although not illustrated in FIG. 7, additional data such as a number of times the historical changes were tested or when the historical changes were tested may also be included in the second table 720.

Referring back to FIG. 6, the candidate change selection module 330 receives the feature vectors 620 corresponding to the candidate changes 610 from the feature vector generation module 335 and provides the feature vectors 620 as input to the machine learning model 365. The machine learning model 365 outputs an expected impact for each of the feature vectors 620. In some embodiments, the output of the machine learning model 365 may be represented as a probability that the candidate change would have a highest expected impact. The machine learning model 365 may be a supervised model that is trained by the training module 340 based on training data associated with historical changes 360 and the resulting changes in performance. The training data may be selected to include historical changes 360 that associated with at least a threshold change in performance, at least a threshold number of tests, less than a threshold time since testing, or other factors to identify robust training data. In some embodiments, the machine learning model 365 is a dynamic regression model (e.g., online linear regression model) that is continuously updated as changes are applied to target workflows and resulting changes in performance is measured. In other embodiments, the machine learning model 365 may be a neural network, a decision tree, a polynomial regression model, a Bayesian network, and the like. After receiving expected impact associated with the candidate changes 610, the change selection module 330 selects a change 630 that has the highest expected impact. In some embodiments, the candidate change selection module 630 may select more than one change 630 to test (e.g., top 3 candidate changes). The selected change 630 is tested to determine whether it actually leads to improvement in performance.

Referring back to FIG. 3, the testing module 345 tests the selected change 630. Prior to testing, the testing module 345 determines whether user action or user approval is required for the selected change 630. In some embodiments, the candidate change 630 may be implemented automatically by the workflow management system 130. For example, if the selected change 630 is to adjust a time at which a step is performed (e.g., send email at 6 am instead of 10 am), the workflow management system 130 may implement the change automatically. In other embodiments, the candidate change 630 may require action. For example, if the selected change 630 is changing email template or call script, the testing module 345 needs the updated email template or call script before being able to test the changes. In cases where user action or user approval is required, the GUI module 305 generates and transmits a recommendation including the selected change 630 to the client device 110. Responsive to receiving user input, the testing module 335 continues with testing the selected change 630.

In some embodiments, the testing module 345 performs A/B test where A corresponds to the target workflow without any changes and B corresponds to the target workflow with the selected change 630. The testing module 345 may determine the duration of the A/B test based on historical usage data associated with the target workflow or statistical analysis. The testing module 345 may also receive the duration of the A/B test from the user. A/B testing is merely exemplary, and other evaluation methods such as pre-post analysis or manual evaluation of user feedback may be used instead. The testing module 345 determines performance of both versions of the target workflow by using both version of the target workflow during the duration of the test and evaluating whether the selected change 630 resulted in performance improvement. If determined that the change leads to improvement, the testing module 345 may set the target workflow with the selected change 630 as the default. However, if determined that the change does not lead to improvement, the testing module 345 discards the selected change 630. The workflow management system 130 may repeat the workflow optimization cycle indefinitely, a fixed number of times, or during a fixed period of time.

Based on the results determined by the testing module 345, the context association graph 345 and the structural change ranking table 350 may be updated. If the selected change 630 is determined to improve or worsen performance, weights of edges connecting context attributes of the target workflow and context attributes of the candidate workflow 530 associated with the selected change 630 may be increased or decreased. Similarly, if the selected change 630 is determined to improve or worsen performance, the value in the structural change ranking table 350 representing a likelihood of the structural change resulting in improved performance may be increased or decreased.

### Exemplary User Interface

FIG. 8 is an exemplary user interface 800 for presenting a recommended change to a workflow, according to an embodiment. The user interface 800 is presented by the GUI module 305 in response to a request from a client device 110 for a recommendation for a change that can be made to a target workflow 810 to improve performance. The GUI module 305 generates and presents the user interface 800, via an application installed on the client device 110, to a user associated with the target workflow 810. A change recommendation 820 for the target workflow 810 may include information such as the type of change, the location of the change, and the expected impact of the change. In the example illustrated in FIG. 8, the change type is changing email template, the location is step 2, and the expected impact is increase in user response by 5%. The change recommendation 820 includes a “replace email template” button 822 and a “ignore” button 824. Responsive to receiving an interaction from the client device 110 with the “replace email template” button 822, the user interface 800 may be updated to provide instructions for uploading a new email template. Responsive to receiving the “ignore” button 824, the change recommendation 820 may be removed from the user interface 800.

The user interface 800 may also include input fields for target workflow modification 830. The input fields allow the user to make changes to one or more steps in the target workflow. Inputs from the user may specify the type of change to make 832, the location of the change 834, and other details regarding the change. The type of change may be selected from a dropdown menu with change options such as adding a step, removing a step, adjusting time of step, adjusting time interval between steps, change action in a step, replacing email template, replacing call script, replacing message template, changing third party system, or other available options. The location of change may indicate which step in the target workflow to apply the change to (e.g., step 3, between steps 2 and 3).

### Exemplary Flowchart for Selecting Similar Workflows

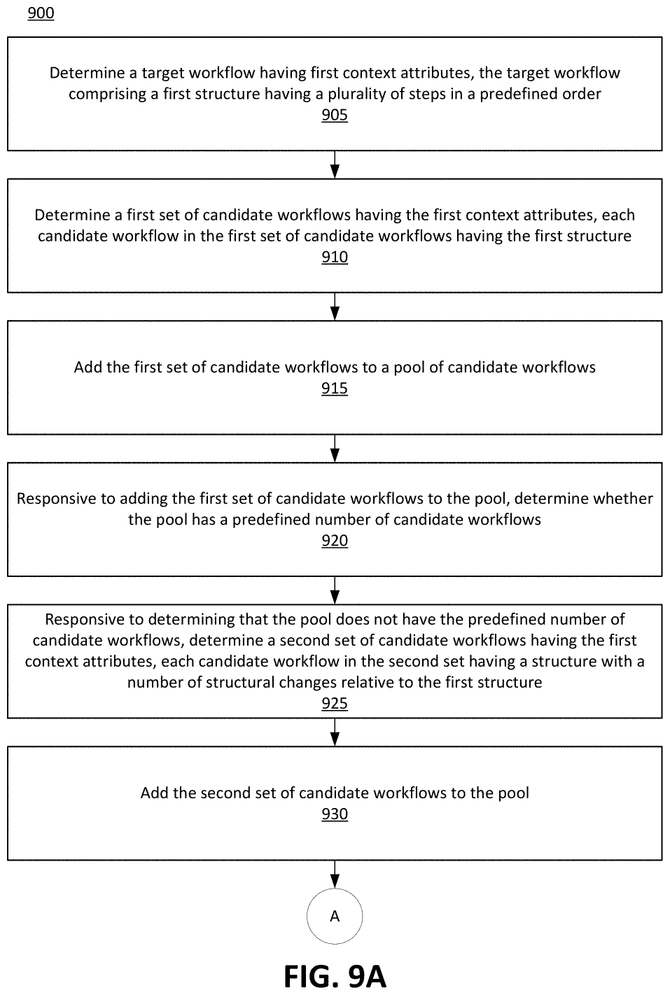

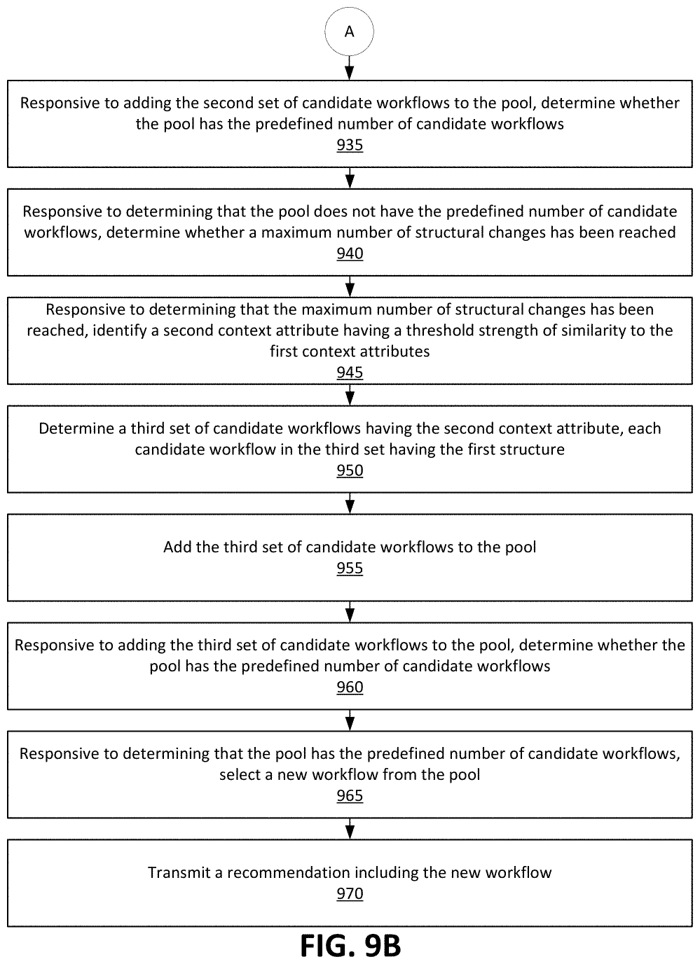

FIGS. 9A and 9B illustrate an exemplary flowchart depicting a process 900 for selecting a new workflow, according to an embodiment. Process 900 begins with the workflow management system 130 determining 905 a target workflow having first context attributes (e.g., table 420). The target workflow has a first structure having a plurality of steps arranged in a predefined order (e.g., table 410). Data describing the first structure such as the types of actions associated with the plurality of steps, how to perform the actions (e.g., email template, call script), time at which one or more steps are performed, or time interval between steps may be specified by a user associated with the target workflow. The workflow management system 130 determines a first set of candidate workflows having the first context attributes from historical workflows, each candidate workflow in the first set of candidate workflows having the first structure of the target workflow. The workflow management system 130 adds 915 the first set of candidate workflows to a pool of candidate workflows.

After adding the first set of candidate workflows, the workflow management system 130 determines 920 whether the pool has a predefined number of candidate workflows. Responsive to determining that the pool does not have the predefined number of candidate workflows, the workflow management system determines 925 a second set of candidate workflows having the first context attributes, where each candidate workflow in the second set has a structure with a number of structural changes relative to the first structure. The workflow management system 130 adds 930 the second set of candidate workflows to the pool of candidate workflows. Responsive to adding the second set of candidate workflows to the pool, the workflow management system 130 determines 935 whether the pool has the predefined number of candidate workflows. Responsive to determining that the pool does not have the predefined number of candidate workflows, the workflow management system determines 940 whether a maximum number of structural changes has been reached. Responsive to determining that the maximum number of structural changes has not been reached, the workflow management system 130 iteratively determines additional second sets of candidate workflows to add to the pool by increasing the number of structural changes during each iteration until reaching the maximum number of structural changes or until the pool has the predefined number of candidate workflows (e.g., using structure relaxation module 320).

Responsive to determining that the maximum number of structural changes has been reached, the workflow management system 130 identifies 945 a second context attribute having a threshold strength of similarity to the first context attribute (e.g., using context relaxation module 315). Based on the second context attribute, the workflow management system 130 determines 950 a third set of candidate workflows having the second context attribute, each candidate workflow in the third set having the first structure. The workflow management system 130 adds 955 the third set of candidate workflows to the pool. Responsive to adding the third set of candidate workflows to the pool, the workflow management system 130 determines 960 whether the pool has the predefined number of candidate workflows. Responsive to determining that the pool has the predefined number of candidate workflows, the workflow management system 130 selects a new workflow from the pool. The workflow management system 130 transmits 970 a recommendation including the selected new workflow to a user (e.g., via the GUI module 305).

### Exemplary Flowchart for Selecting a Promising Change

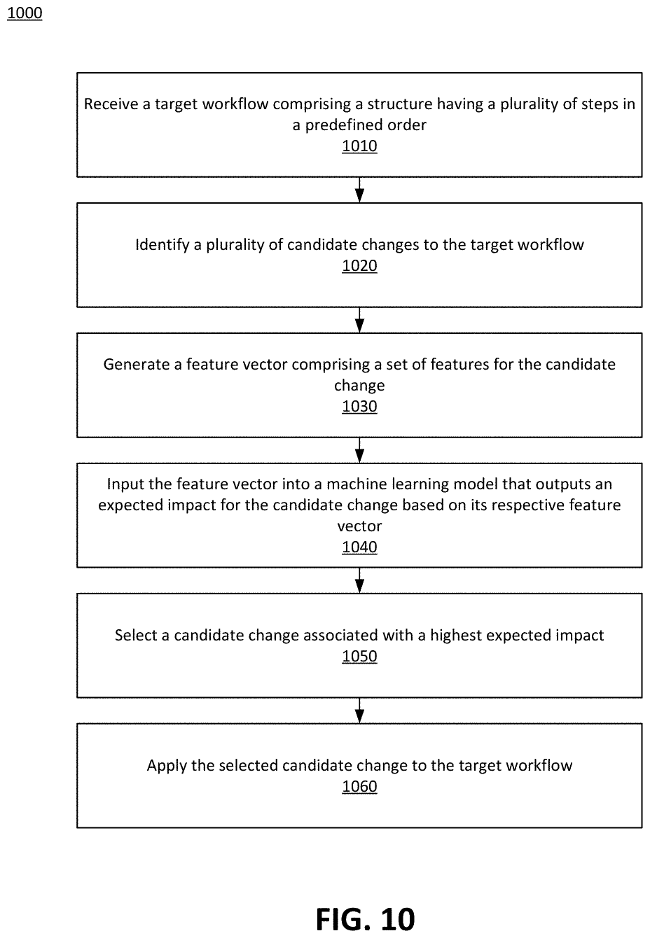

FIG. 10 illustrates an exemplary flowchart depicting a process 1000 for selecting a change to apply to a target workflow, according to an embodiment. The process 1000 begins with the workflow management system 130 receiving 1010 a target workflow comprising a structure having a plurality of steps in a predefined order (e.g., via GUI module 305). The workflow management system 130 identifies 1020 a plurality of candidate changes to the target workflow. The plurality of candidate changes are historical changes that were previously made to candidate workflows that are similar to the target workflow. For each candidate change, the workflow management system 130 generates 1030 a feature vector comprising a set of features associated with the candidate change. The set of features may include one or more of: a type of action associated with the candidate change, a timing associated with the candidate change, an order of a step to which the candidate change was applied within the corresponding candidate workflow, historical impact associated with the candidate change, and a number of times the candidate change was tested. For each candidate change, the workflow management system 130 inputs 1040 the feature vectors into a machine learning model (e.g., machine learning model 365) that outputs an expected impact for the candidate change based on its respective feature vector. The machine learning model is trained using training data including changes made to historical workflows and corresponding changes in performance of the historical workflow. The workflow management system selects 1050 a candidate change associated with a highest expected impact. The workflow management system 130 applies 1060 the selected candidate change to the target workflow.

### Computing Machine Architecture

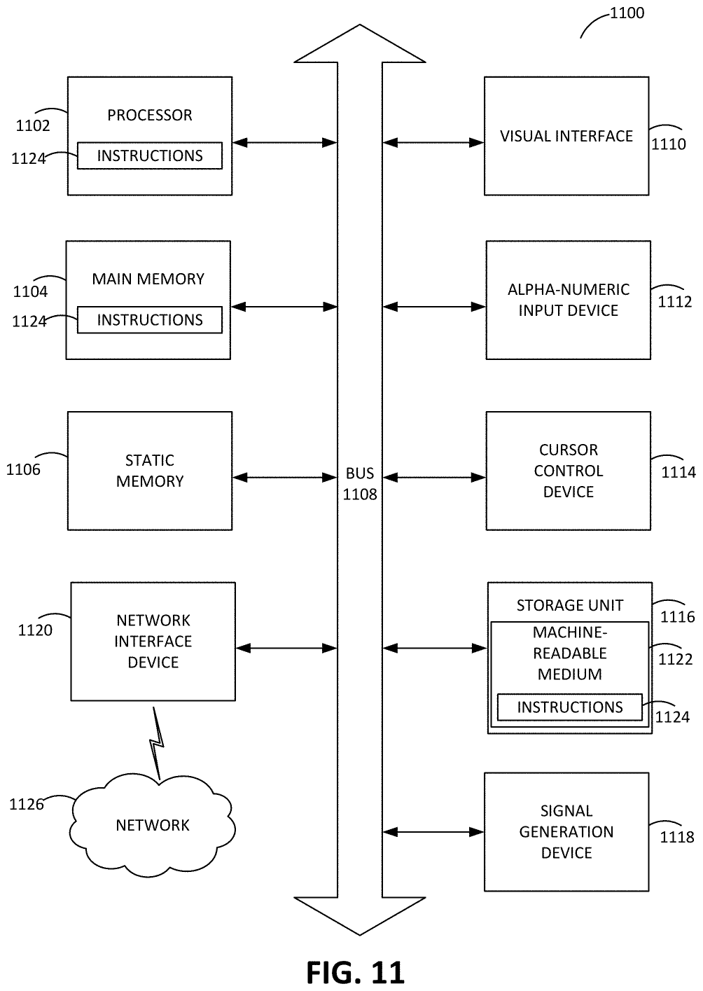

FIG. 11 is a block diagram illustrating components of an example machine able to read instructions from a machine-readable medium and execute them in a processor (or controller). Specifically, FIG. 11 shows a diagrammatic representation of a machine in the example form of a computer system 1100 within which program code (e.g., software) for causing the machine to perform any one or more of the methodologies discussed herein may be executed. The program code may be comprised of instructions 1124 executable by one or more processors 1102. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1124 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 1100 includes a processor 1102 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1104, and a static memory 1106, which are configured to communicate with each other via a bus 1108. The computer system 1100 may further include visual display interface 1110. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 1110 may include or may interface with a touch enabled screen. The computer system 1100 may also include alphanumeric input device 1112 (e.g., a keyboard or touch screen keyboard), a cursor control device 1114 (e.g., a mouse, a trackball, a joystick, a motion sensor, or other pointing instrument), a storage unit 1116, a signal generation device 1118 (e.g., a speaker), and a network interface device 1120, which also are configured to communicate via the bus 1108.

The storage unit 1116 includes a machine-readable medium 1122 on which is stored instructions 1124 (e.g., software) embodying any one or more of the methodologies or functions described herein. The instructions 1124 (e.g., software) may also reside, completely or at least partially, within the main memory 1104 or within the processor 1102 (e.g., within a processor's cache memory) during execution thereof by the computer system 1100, the main memory 1104 and the processor 1102 also constituting machine-readable media. The instructions 1124 (e.g., software) may be transmitted or received over a network 1126 via the network interface device 1120.

While machine-readable medium 1122 is shown in an example embodiment to be a single medium, the term “machine-readable medium” should be taken to include a single medium or multiple media (e.g., a centralized or distributed database, or associated caches and servers) able to store instructions (e.g., instructions 1124). The term “machine-readable medium” shall also be taken to include any medium that is capable of storing instructions (e.g., instructions 1124) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for optimizing workflows through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A non-transitory computer readable storage medium comprising stored instructions, the instructions when executed by one or more processors cause the one or more processors to:
determine a target workflow having first context attributes, the target workflow comprising a first structure having a plurality of steps in a predefined order;
determine a first set of candidate workflows having the first context attributes, each candidate workflow in the first set of candidate workflows having the first structure;
add the first set of candidate workflows to a pool of candidate workflows;
responsive to adding the first set of candidate workflows to the pool, determine whether the pool has a predefined number of candidate workflows;
responsive to determining that the pool does not have the predefined number of candidate workflows, determine a second set of candidate workflows having the first context attributes, each candidate workflow in the second set having a structure with a number of structural changes relative to the first structure;
add the second set of candidate workflows to the pool;
responsive to adding the second set of candidate workflows to the pool, determine whether the pool has the predefined number of candidate workflows;
responsive to determining that the pool does not have the predefined number of candidate workflows, determine whether a maximum number of structural changes has been reached;
responsive to determining that the maximum number of structural changes has been reached, identify a second context attribute having a threshold strength of similarity to the first context attributes;
determine a third set of candidate workflows having the second context attribute, each candidate workflow in the third set having the first structure;
add the third set of candidate workflows to the pool;
responsive to adding the third set of candidate workflows to the pool, determine whether the pool has the predefined number of candidate workflows;
responsive to determining that the pool has the predefined number of candidate workflows, select a new workflow from the pool; and
transmit, to a client device, a recommendation including the new workflow.

2. The non-transitory computer readable storage medium of claim 1, wherein the instructions further cause the one or more processors to:
iteratively determine additional second sets of candidate workflows to be added to the pool, wherein the number of structural changes is increased by one during each iteration until reaching a maximum number of structural change or until the pool has the predefined number of candidate workflows.

3. The non-transitory computer readable storage medium of claim 2, wherein the instructions further cause the one or more processors to:
select, for a given iteration of determining an additional second set of candidate workflows, a structural change from a ranked list of structural changes based on a number of structural changes associated with the iteration; and
identify candidate workflows having the selected structural change to include in the additional second set of candidate workflows.

4. The non-transitory computer readable storage medium of claim 3, wherein the instructions to select the structural change for the given iteration further cause the one or more processors to select from candidate structural changes including one or more of:
performing a different action type during a step, performing an additional step that is not included in the first structure, not performing one of the plurality of steps in the first structure, performing a same action type with a different script, performing a step at a different time, and adjusting a time before or after a step.

5. The non-transitory computer readable storage medium of claim 1, wherein the instructions further cause the one or more processors to:
iteratively relax the threshold strength of similarity each time the maximum number of structural changes has been reached for a given threshold strength of similarity until reaching a maximum relaxation of the threshold strength or until the pool has the predefined number of candidate workflows.

6. The non-transitory computer readable storage medium of claim 1, wherein the instructions to identify the second context further cause the one or more processors to:
transmit a query to a context association graph, the query including the first context attributes and the threshold strength of similarity, wherein the context association graph includes vertices representing context attributes connected by edges that each represents a strength of similarity between two context attributes; and
receive the second context attribute that is connected to at least one of the first context attributes by an edge having the threshold strength of similarity.

7. The non-transitory computer readable storage medium of claim 1, wherein the instructions to select the new workflow from the pool, further cause the one or more processors to:
for each candidate workflow in the pool:
determine a context similarity score representing a strength of similarity between the first context attributes and context attributes associated with the candidate workflow;
determine structure transferability score representing a likelihood that the candidate workflow would perform within a threshold of current performance given the first context attributes; and
determine an estimated performance of the candidate workflow based on the context similarity score and the structure transferability score;
rank the candidate workflows in the pool based on the estimated performances; and
select a candidate workflow with a highest ranking as the new workflow, wherein the estimated performance of the selected candidate workflow is greater than current performance of the target workflow.

8. A method comprising:
determining, by a server, a target workflow having first context attributes, the target workflow comprising a first structure having a plurality of steps in a predefined order;
determining, by the server, a first set of candidate workflows having the first context attributes, each candidate workflow in the first set of candidate workflows having the first structure;
adding, by the server, the first set of candidate workflows to a pool of candidate workflows;
responsive to adding the first set of candidate workflows to the pool, determining, by the server, whether the pool has a predefined number of candidate workflows;
responsive to determining that the pool does not have the predefined number of candidate workflows, determining, by the server, a second set of candidate workflows having the first context attributes, each candidate workflow in the second set having a structure with a number of structural changes relative to the first structure;
adding, by the server, the second set of candidate workflows to the pool;
responsive to adding the second set of candidate workflows to the pool, determining, by the server, whether the pool has the predefined number of candidate workflows;
responsive to determining that the pool does not have the predefined number of candidate workflows, determining, by the server, whether a maximum number of structural changes has been reached;
responsive to determining that the maximum number of structural changes has been reached, identifying, by the server, a second context attribute having a threshold strength of similarity to the first context attributes;
determining, by the server, a third set of candidate workflows having the second context attribute, each candidate workflow in the third set having the first structure;
adding, by the server, the third set of candidate workflows to the pool;
responsive to adding the third set of candidate workflows to the pool, determining, by the server, whether the pool has the predefined number of candidate workflows;
responsive to determining that the pool has the predefined number of candidate workflows, selecting, by the server, a new workflow from the pool; and
transmitting, by the server to a client device, a recommendation including the new workflow.

9. The method of claim 8, further comprising iteratively determining additional second sets of candidate workflows to be added to the pool, wherein the number of structural changes is increased by one during each iteration until reaching a maximum number of structural change or until the pool has the predefined number of candidate workflows.

10. The method of claim 9, further comprising:
selecting, for a given iteration of determining an additional second set of candidate workflows, a structural change from a ranked list of structural changes based on a number of structural changes associated with the iteration; and
identifying candidate workflows having the selected structural change to include in the additional second set of candidate workflows.

11. The method of claim 10, wherein selecting the structural change for the given iteration comprises selecting from candidate structural changes including one or more of:
performing a different action type during a step, performing an additional step that is not included in the first structure, not performing one of the plurality of steps in the first structure, performing a same action type with a different script, performing a step at a different time, and adjusting a time before or after a step.

12. The method of claim 8, further comprising iteratively relaxing the threshold strength of similarity each time the maximum number of structural changes has been reached for a given threshold strength of similarity until reaching a maximum relaxation of the threshold strength or until the pool has the predefined number of candidate workflows.

13. The method of claim 8, wherein identifying the second context comprises:
transmitting a query to a context association graph, the query including the first context attributes and the threshold strength of similarity, wherein the context association graph includes vertices representing context attributes connected by edges that each represents a strength of similarity between two context attributes; and
receiving the second context attribute that is connected to at least one of the first context attributes by an edge having the threshold strength of similarity.

14. The method of claim 8, wherein selecting the new workflow from the pool, further comprises:
for each candidate workflow in the pool:
determining a context similarity score representing a strength of similarity between the first context attributes and context attributes associated with the candidate workflow;
determining a structure transferability score representing a likelihood that the candidate workflow would perform better than the target workflow given the first context attributes; and
determining an estimated performance of the candidate workflow based on the context similarity score and the structure transferability score;
ranking the candidate workflows in the pool based on the estimated performances; and
selecting a candidate workflow with a highest ranking as the new workflow.

15. A system comprising:
one or more processors; and
a non-transitory computer-readable medium comprising computer program instructions that, when executed by the one or more processors, cause the one or more processors to perform operations comprising:
determining a target workflow having first context attributes, the target workflow comprising a first structure having a plurality of steps in a predefined order;
determining a first set of candidate workflows having the first context attributes, each candidate workflow in the first set of candidate workflows having the first structure;
adding the first set of candidate workflows to a pool of candidate workflows;
responsive to adding the first set of candidate workflows to the pool, determining, whether the pool has a predefined number of candidate workflows;
responsive to determining that the pool does not have the predefined number of candidate workflows, determining a second set of candidate workflows having the first context attributes, each candidate workflow in the second set having a structure with a number of structural changes relative to the first structure;
adding the second set of candidate workflows to the pool;
responsive to adding the second set of candidate workflows to the pool, determining whether the pool has the predefined number of candidate workflows;
responsive to determining that the pool does not have the predefined number of candidate workflows, determining whether a maximum number of structural changes has been reached;
responsive to determining that the maximum number of structural changes has been reached, identifying a second context attribute having a threshold strength of similarity to the first context attributes;
determining a third set of candidate workflows having the second context attribute, each candidate workflow in the third set having the first structure;
adding the third set of candidate workflows to the pool;
responsive to adding the third set of candidate workflows to the pool, determining whether the pool has the predefined number of candidate workflows;
responsive to determining that the pool has the predefined number of candidate workflows, selecting a new workflow from the pool; and
transmitting, to a client device, a recommendation including the new workflow.

16. The system of claim 15, wherein the computer program instructions cause the one or more processor to further perform operations comprising:
iteratively determine additional second sets of candidate workflows to be added to the pool, wherein the number of structural changes is increased by one during each iteration until reaching a maximum number of structural change or until the pool has the predefined number of candidate workflows.

17. The system of claim 16, wherein the computer program instructions cause the one or more processor to further perform operations comprising:
selecting, for a given iteration of determining an additional second set of candidate workflows, a structural change from a ranked list of structural changes based on a number of structural changes associated with the iteration; and
identifying candidate workflows having the selected structural change to include in the additional second set of candidate workflows.

18. The system of claim 17, wherein selecting the structural change for the given iteration comprises selecting from candidate structural changes including one or more of:
performing a different action type during a step, performing an additional step that is not included in the first structure, not performing one of the plurality of steps in the first structure, performing a same action type with a different script, performing a step at a different time, and adjusting a time before or after a step.

19. The system of claim 15, wherein the computer program instructions cause the one or more processor to further perform operations comprising:
iteratively relaxing the threshold strength of similarity each time the maximum number of structural changes has been reached for a given threshold strength of similarity until reaching a maximum relaxation of the threshold strength or until the pool has the predefined number of candidate workflows.

20. The system of claim 15, wherein the computer program instructions cause the one or more processor to further perform operations comprising:
transmitting a query to a context association graph, the query including the first context attributes and the threshold strength of similarity, wherein the context association graph includes vertices representing context attributes connected by edges that each represents a strength of similarity between two context attributes; and
receiving the second context attribute that is connected to at least one of the first context attributes by an edge having the threshold strength of similarity.
